(19) United States
(12) Patent Application Publication
(10) Pub. No.: US 2004/0071414 A1
(43) Pub. Date: Apr. 15, 2004

(54) System, controller and method for fusion splicing at least one pair of optical fibers

(75) Inventors: Yue Liang, Peachtree City, GA (US); Takeshi Kawana, Peachtree City, GA (US); Toshio Shibata, Kashiwa City (JP); Hideki Watanabe, Chiba City (JP)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignees: Fitel Interconnectivity Corp., Peachtree City, GA; The Furukawa Electric Co., Ltd., Tokyo (JP)

(21) Appl. No.: 10/272,266

(22) Filed: Oct. 15, 2002

(51) Int. Cl. G02B 6/255

(52) U.S. Cl. 385/96

(57) ABSTRACT

A system is provided for fusion splicing at least one pair and, more typically a plurality of pairs (e.g., 24 pairs), of optical fibers together. The system includes a pair of electrodes and a controller. The optical fibers are positioned between the pair of electrodes. In this regard, the electrodes are capable of passing an electric current therebetween to create an electric arc capable of heating an end of each of the optical fibers. The controller is capable of controlling the electrodes to thereby pass the current therebetween to create the electric arc. Advantageously, the controller is capable of controlling the electrodes to pass an initial current to thereby create and maintain an initial electric arc and thereafter pass a processing current to thereby create and maintain a processing electric arc, where the initial current is higher than the processing current.

### FIELD OF THE INVENTION

The present invention relates generally to a system, controller and method of fusion splicing fibers and, more particularly, relates to a system, apparatus and method of fusion splicing fibers by heating ends of the fibers with electric arcs of differing powers and durations.

### BACKGROUND OF THE INVENTION

In many industries that employ fiber optic communications, the length of optical fibers over which such communications travel is continuously increasing. It will be appreciated that when utilizing optical fibers of great lengths, it is often desirable or necessary to splice or otherwise join optical fibers of different lengths, particularly at the terminal ends of the optical fibers. In this regard, many techniques have been developed to splice optical fibers, many of which revolve around fusion-splicing optical fibers together. One such technique, for example, is referred to as fusion splicing by discharge.

According to the fusion splicing by discharge technique, an electric discharge is used to heat the ends of fibers such that the fibers melt together and fuse into one fiber. Generally, the process of fusion splicing by discharge begins by removing fiber coatings from the end portions of the fibers, and thereafter the fibers are cleaved. The ends of the fibers are then aligned with one another with a gap therebetween. The ends of the fibers are then moved toward one another while electrodes on either side of the fibers generate an electric discharge, otherwise referred to as an electric arc, by passing a current therebetween. The electric arc is then maintained for a predefined period of time to melt the ends of the fiber and thereby fuse the fibers together as the fiber ends engage one another.

It will be appreciated that as the communication demands on systems utilizing fiber optic communications increase, it is often desirable or otherwise necessary to employ ribbons that each include a plurality of optical fibers. As before, then, it could be desirable or otherwise necessary to simultaneously splice together the plurality of fibers of the ribbons of fibers. And whereas more conventional fusion splicing techniques may be used for ribbons of optical fibers, such methods become more difficult as the number of fibers in the ribbons increase. As the number of fibers that need to be simultaneously spliced increases, the distance between electrodes on either side of the fibers, otherwise known as the electrode gap, increases. As the electrode gap increases, then, a heating distribution imbalance can be created in the electrode gap. In addition, as the electrode gap increases with the number of fibers simultaneously spliced, the amount of current required to establish a stable electric arc increases. In this regard, if insufficient current is attempted to pass between the electrodes, the electric arc may never be established or may be unstable (flicker).

To correct for the imbalance in the heating distribution, techniques have been developed to balance the heating distribution across the fibers. According to one such technique, the fibers are offset from an axis between the electrodes and the shape of the electric arc between the electrodes is curved. By offsetting the fibers and curving the electric arc between the electrodes, a relatively isothermal heat distribution can be achieved across the electrodes.

In addition to techniques to balance the heat distribution, the current passed between the electrodes to generate the electric arc has been increased to establish a stable arc between the electrodes. And whereas increasing the current provides sufficient power for the electric arc to splice the fibers together, such increased current has drawbacks. In this regard, increasing the current across the electrodes can result in excess power across the electrodes which, in turn, can result in overheating of the ends of the fibers. For temperature sensitive optical fibers, then, overheating can result in high and inconsistent losses at the splice due to undesirable dopant diffusion within the fibers. Also, in splicing dissimilar optical fibers, such as fibers having different mode field diameters, overheating can result in high and inconsistent losses. In this regard, high and inconsistent losses can be obtained in such instances as a relatively precise temperature and temperature distribution are required to control the diffusion of dopant across the splice such that the mode field diameters in both sides can match each other with low splicing loss.

More particularly, different fibers have different refractive index profiles, typically generated by doping a small amount of one or more materials (e.g., germanium, fluorine, etc.) into the cores and/or claddings of the fibers. For one conventional single mode fiber (e.g., a step-index fiber configured according to G. 652), the refractive index profile is relative simple and, as such, the conventional single mode fiber is not very sensitive to temperature for fusion splicing. In contrast, fibers designed for special application, such as fibers configured according to G.655, have very complicated refractive index profiles and/or a relative small mode field diameter. Thus, such fibers are very sensitive to the splicing condition and, as such, require a more defined temperature distribution.

### SUMMARY OF THE INVENTION

In light of the foregoing background, an improved system, controller and method are provided for fusion splicing at least one pair of optical fibers together. According to embodiments of the present invention, pairs of optical fibers are spliced together by applying different currents across a pair of electrodes for different durations. In this regard, a higher, initial current can be passed between the electrodes to create and maintain an electric arc having a higher power to thereby establish a stable electric arc, particularly in instances where the electrode gap is increased due to simultaneously splicing a greater plurality of fibers. Once the stable arc has been established, then, a lower, processing current can be passed between the electrodes to create and maintain an electric arc having a lower power to thereby fusion splice the fibers together. By reducing the current between the electrodes, and therefore the power of the electric arcs, the system, controller and method of embodiments of the present invention can reduce overheating of the ends of the fibers. And by reducing overheating of the ends of the fibers, the system, controller and method of embodiments of the present invention can reduce losses in the splices.

According to one aspect of the present invention, a system is provided for fusion splicing at least one pair and, more typically a plurality of pairs (e.g., 24 pairs), of optical fibers together. The system includes a pair of electrodes and a controller. The pair of electrodes are positioned laterally on either side of the pairs of optical fibers. In this regard, the electrodes are capable of passing an electric current therebetween to create an electric arc capable of heating an end of each of the optical fibers. The controller is capable of controlling the electrodes to thereby pass the current therebetween to create the electric arc. Advantageously, the controller is capable of controlling the electrodes to pass an initial current to thereby create and maintain an initial electric arc and thereafter pass a processing current to thereby create and maintain a processing electric arc, where the initial current is higher than the processing current.

More particularly, the controller can be capable of controlling the electrodes to maintain the initial electric arc for an initial period of time. Thereafter, the controller can maintain the processing electric arc for a processing period of time, where the initial period of time is shorter than the processing period of time. The controller can also be capable of controlling the electrodes based upon at least one characteristic of the pairs of optical fibers. In this regard, the controller can be capable of selecting the initial current and the processing current based upon at least one characteristic of the pairs of optical fibers.

In one embodiment, the electrodes define an axis therebetween. In such embodiments, the ends of the pairs of optical fibers can be offset in at least one direction by a predefined distance from the axis. More particularly, in such embodiments the ends of the pairs of optical fibers can be positioned such that ends face one another and the fibers extend longitudinally therefrom in opposing directions. As such, the ends of the pairs of optical fibers can be offset longitudinally by a predefined distance from the axis. In another embodiment, at least one pair of optical fibers includes a first optical fiber having a first mode field diameter and a second optical fiber having a second mode field diameter. And in those embodiments, the first mode field diameter is larger than the second mode field diameter.

According to other aspects of the present invention, a controller and method are provided for fusion splicing optical fibers. Therefore, embodiments of the present invention provide an improved system, controller and method of fusion splicing pairs of optical fibers together. The system, controller and method are capable of fusion splicing a large number of pairs of fibers without increasing losses in the fibers in the same manner as fusion splicing large numbers of fibers according to conventional techniques. In this regard, the system, controller and method are capable of passing a higher, initial current between electrodes to establish a stable electric arc between the electrodes. To fusion splice the fibers without overheating the ends of the fibers then, the system, controller and method of embodiments of the present invention can pass a lower, processing current between the electrodes to fusion splice the fibers together.

### BRIEF DESCRIPTION OF THE DRAWINGS

Having thus described the invention in general terms, reference will now be made to the accompanying drawings, which are not necessarily drawn to scale, and wherein:

FIG. 1 is a schematic block diagram of a system for fusion splicing at least one pair of optical fibers together, according to one embodiment of the present invention;

FIGS. 2A and 2B are schematic illustrations of the heat distribution between electrodes according to embodiments of the present invention where the heat distribution is unaffected and curved, respectively;

FIG. 3 is a flow chart illustrating various steps in a method of fusion splicing at least one pair of optical fibers together, according to one embodiment of the present invention;

FIG. 4 is a graph illustrating frequency of loss in one example of splicing temperature sensitive fibers according to a conventional technique;

FIG. 5 is a graph illustrating frequency of loss in the example of FIG. 4 where the fibers are spliced according to embodiments of the present invention;

FIG. 6 is a graph illustrating frequency of loss in another example of splicing dissimilar fibers according to a conventional technique; and

FIG. 7 is a graph illustrating frequency of loss in the example of FIG. 6 where the fibers are spliced according to embodiments of the present invention.

### DETAILED DESCRIPTION OF THE INVENTION

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

Like numbers refer to like elements throughout.

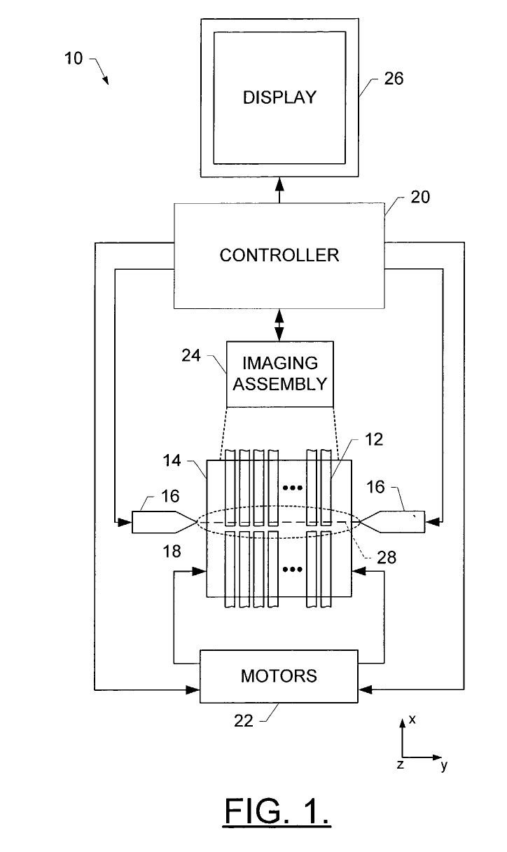

Referring to FIG. 1, a system 10 is shown for splicing at least two optical fibers 12 together, according to one embodiment of the present invention. Although the system is capable of splicing two fibers together, it will be appreciated that embodiments of the present invention are capable of splicing, and more typically splice, a greater plurality of fibers together. Thus, the system is capable of splicing ribbons of fibers together, where each ribbon includes 2, 4, 6, 8, 10, 12, 16, 24 or more fibers, for example. The fibers can comprise any of a number of different types of optical fibers. For example, the fibers can comprise any of a number of fibers configured according to the International Telecommunication Union's (ITU) G.650 Series Recommendations, including G.650, G.651, G.652, G.653, G.654, G.655 and G.scl. More particularly, for example, the fibers can comprise Allwave model fibers (G.652 compliant), Matched Cladding model fibers (G.652 compliant), and/or Truewave model fibers (G.655 compliant), all manufactured by OFS Fitel, LCC of Norcross, Ga.

The system 10 includes an alignment assembly 14 capable of aligning the fibers 12 to be spliced together. The alignment assembly can comprise any of a number of different known assemblies, such as v-groove jigs and/or a fiber moving devices. The system also includes a pair of electrodes 16 capable of passing a current therebetween to provide an electric arc 18 across the fibers to be spliced together to thereby heat the ends of the fibers such that the fibers can be spliced together. The electrodes can be made from any of a number of different known materials such as, for example, tungsten.

To position the fibers 12 being spliced into alignment with one anther, such as by aligning the cores and/or claddings of the fibers, the controller 20 can be capable of controlling motors 22, drives or the like, to move the fibers in any of three directions (x, y or z). The controller can also control the motors to advance the ends of the fibers toward one another during the splicing process, as described below. In addition, by moving the fibers, the controller can also position the fibers relative to the electrodes. In this regard, the fibers can be positioned to receive at least a portion of the electric arc between the electrodes.

To provide the current to control the electrodes 16 to splice the fibers 12 together, the system includes a controller 20. The controller can comprise any of a number of different processing devices capable of functioning according to embodiments of the present invention. In this regard, the controller can be capable of controlling the electrical current passing between the electrodes in any of a number of different manners. In one embodiment, for example, the controller controls the electrical current according to the HHT fusion splicing technique, as such is known. Generally, the HHT technique is a voltage trigger method whereby the current across the electrodes is created by high frequent power supply switching circuit. For example, in splicing twenty-four pairs of fibers, the controller can create a current discharge between the electrodes that varies between 32.5 mA and 17 mA by the switching circuit with a voltage of approximately 1 kV at a frequency of 110 kHz.

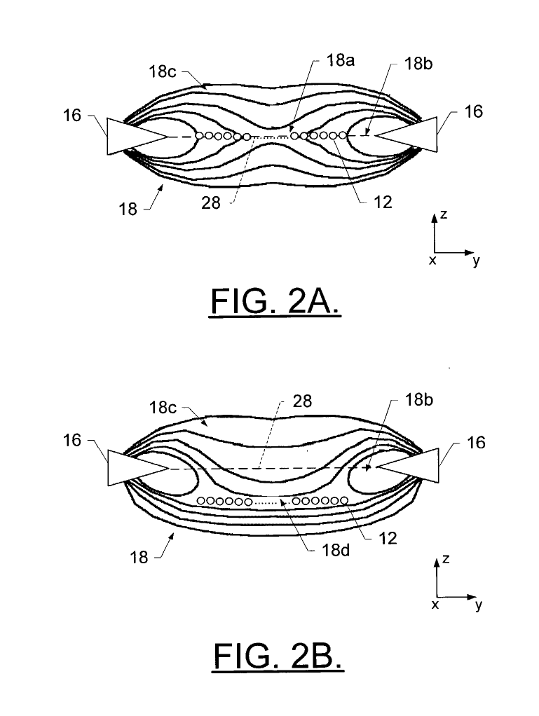

As the number of fibers 12 simultaneously spliced together increases, it will be appreciated that the gap between the electrodes 16, referred to as the electrode gap, also increases. As described in the background section, as the electrode gap increases, a heat distribution imbalance can be created in the electrode gap. As shown in FIG. 2A, increasing the electrode gap creates a heat distribution between the electrodes 16 that includes a region where the heating is adequate for splicing the fibers (designated 18a). However, the heat distribution also includes regions where the heat is at a level too high for the fibers (designated 18b), as well as regions where the heat level is too low to splice the fibers (designated 18c). To control the electric arc 18 such that most, if not all, of the fibers can be within the region adequate for splicing the fibers, altering materials can be situated proximate the electric arc to curve the electric arc such that the region adequate for splicing the fibers increases in length, as shown in FIG. 2B (designated 18d). In one embodiment, for example, the electrodes, such as those made from tungsten, can include a special treatment, such as by including small Zirconiated and/or Lanthanated materials, to thereby curve the electric arc between the electrodes.

As shown, the region 18d adequate for splicing the fibers 12 is offset in the z direction from an axis 28 between the electrodes 16. As such, the controller 20 can be capable of controlling the motors 22, drives or the like, to position the fibers such that the fibers are offset in the z direction from the axis, and within the region adequate for splicing the fibers. Typically, the amount of offset of the fibers from the axis depends upon the frequency at which the voltage is applied to create the current across the electrodes, and upon the electrode gap as defined by the number of pairs of fibers simultaneously spliced together. For example, for a current discharge across the electrodes created by applying a voltage at a frequency of 110 kHz, and an electrode gap adapted to splice twenty-four pairs of fibers simultaneously (e.g., an electrode gap approximately 8 mm long), the fibers can be offset from the axis by 0.5 mm.

The controller 20 can also be capable of controlling motors, drives or the like (not shown) to move the electrodes 16 closer together or farther apart, depending upon the number of fibers. Each electrode is typically spaced apart based upon the lateral distance between the electrode and the pair of fibers closest to the respective electrode. For example, each electrode can be spaced laterally from the closest pair of fibers by 1 mm. Also, although controller has been shown and described as controlling the motors 22 to position the fibers relative to the electrodes, it should be understood that the controller can additionally, or alternatively, be capable of controlling the motors to position the electrodes relative to the fibers, without departing from the spirit and scope of the present invention.

The system 10 can also include an imaging assembly 24 and a display 26, both electrically connected to the controller 20. The imaging assembly is capable of imaging the optical fibers 12 and thereafter processing the images. In turn, the display is capable of presenting the image of the optical fibers. More particularly, imaging assembly is capable of imaging the ends of the fibers to thereby facilitate alignment of the fibers before the fibers are spliced together. The imaging assembly can comprise any of a number of different imaging devices, assemblies or systems such as, for example, one or more charge-coupled device (CCD) image sensors coupled to an image processing module. In addition, the imaging assembly can include any number of other additional optical elements designed to enhance operation of the imaging assembly, including mirrors, light sources, lenses or the like.

It will be appreciated that the alignment assembly 14, electrodes 16, motors 22, imaging assembly 24 and 26, as well as the functions of the controller 20 to align and position the fibers and/or electrodes, can be embodied in any of a number of known mass fusion splicer systems. For example, when the number of fibers 12 does not exceed 24 pairs of fibers, the aforementioned elements can be embodied in a model S199-M24 mass fusion splicer manufactured by Furukawa Electric Co., Ltd. of Tokyo, Japan. In contrast to conventional mass fusion splicers, however, the controller of the system 10 of the present invention can continuously control the current between the electrodes and, thus, the power of the electric arc 18 in a two-step process to thereby splice the fibers together, as described below.

As explained in the background section, in addition to techniques to balance the heat distribution across large numbers of fibers, the current passed between the electrodes to generate the electric arc has been increased to establish a stable arc between the electrodes. As also explained, when fibers are spliced together with such increased power, losses in the splice can also increase due to overheating of the fibers, depending on the fiber types and combinations being spliced. Therefore, according to embodiments of the present invention, the controller 20 is capable of passing a larger, initial current across the electrodes 16 for an initial time period to thereby create and maintain an initial electric arc 18 between the electrodes. In this regard, the controller can provide sufficient current necessary to establish a stable electric arc between the electrodes. In this regard, an electric arc is considered stable if the electric arc has sufficient power to extend between the electrodes with a stable, relatively constant temperature profile, and without flickering or otherwise exhibiting significant fluctuations in temperature.

After establishing the stable electric arc, then, the controller can reduce the initial current to a smaller, processing current across the electrodes for a processing time period to create and maintain a processing electric arc between the electrodes to thereby fusion splice the fibers together with a more desirable temperature condition. Therefore, in contrast to conventional splicing techniques in which a single electric arc is maintained to splice the fibers together, embodiments of the present invention create and maintain two different electric arcs of differing powers to thereby reduce losses in the splicing of the fibers. As described herein, as the different currents are passed to create and maintain different electric arcs, the voltage between the electrodes is maintained approximately the same. As such, the electric arcs can be described in relation to the powers of the electric arcs, which can be defined in terms of the respective currents.

The initial current and initial time period can be selected in any of a number of different manners to thereby establish the stable electric current. For example, the initial current (and thus the initial electric arc) and the initial time can be selected based upon the distance of the electrode gap, as defined by the number of pairs of optical fibers 12. In this regard, the initial current and time typically increase as the electrode gap increases as the current must traverse a larger distance and supply heat to more fibers. Although typically not necessary, the initial current and initial time can be further selected based upon one or more characteristics of the optical fibers such as, for example, the material structure (e.g., refractive index profile) and component (e.g., dopant type, if any) of the optical fibers (e.g., core and cladding) being spliced, as well as the mode field diameter of the fibers, to thereby establish a stable temperature profile. In this regard, different fibers have different refractive index profiles, typically generated by doping an amount of one or more materials (e.g., germanium, fluorine, etc.) into the cores and/or claddings of the fibers. For one conventional single mode fiber (e.g., a fiber configured according to G. 652), the refractive index profile is relative simple and, as such, the conventional single mode fiber is not very sensitive to temperature for fusion splicing. However, fibers designed for special application, such as fibers configured according to G.655, have very complicated refractive index profiles and/or a relative small mode field diameter. Thus, such fibers are very sensitive to the splicing condition and, as such, require a more stable and defined temperature distribution.

In instances in which the initial current and time are selected based upon characteristics of the fibers, the initial current and time typically increase as the refraction index profile of the fibers becomes complicated, and/or the each pair of fibers includes fibers having significantly different mold field diameters. In one example, explained below in conjunction with FIG. 5, the initial current and initial time are selected to be 27.3 mA and 3 seconds, respectively.

As stated, once the stable arc has been established, the controller 20 can decrease the initial current to a lower, processing current across the electrodes 16 to create a processing electric arc between the electrodes. The controller can then fusion splice the fibers 12 together by maintaining the processing current and, thus, the processing electric arc across the electrodes for a processing time period while the ends of the fibers are butted together. In this regard, the processing period of time is typically longer than the initial period of time. Like the initial current and initial time period, the processing current and processing time period can be selected in any of a number of different manners to thereby fusion splice the optical fibers together. For example, the processing current (and thus the processing electric arc) and the processing time can be selected based upon the distance of the electrode gap, with the processing current and time typically increasing with the electrode gap. Additionally, the processing current and processing time can be selected based upon one or more characteristics of the optical fibers such as, for example, the doping materials in the optical fibers (e.g., core and cladding) being spliced and the fiber structures (e.g., refraction index profile and mode field diameter), to thereby achieve an optimized temperature condition. For example, the temperature, and therefore the processing current, typically decreases as refractive index profile of the fibers becomes more complicated, and/or when the mold field diameters of each fiber of each pair of fibers differ. At the same time, the processing time typically increases as the as refractive index profile of the fibers becomes more complicated, and/or when the mold field diameters of each fiber of each pair of fibers differ, to thereby accommodate the more complicated refractive index profile and/or splicing dissimilar fibers. In the example explained below in conjunction with FIG. 5, the processing current and processing time are selected to be 23.1 mA and 12 seconds, respectively.

Advantageously, the fibers 12 spliced together according to embodiments of the present invention need not be of the same type. In this regard, the pairs of fibers spliced together can have different mode field diameters. In such instances, one fiber of each pair being spliced together may have preferred initial and processing currents and times that differ from the other fiber of the respective pair. Thus, the controller 20 can select the respective currents and times based upon either of the fibers. In one advantageous embodiment, for example, where one fiber has a larger mode field diameter than the other, the respective currents and times can be selected based upon the average between the larger mode field diameter and the smaller mode field diameter. As such, the fiber with the smaller mode field diameter can expand slightly more than typical to match the fiber having the larger mode field diameter, with the match being aided by more dopant material diffusing in the fiber having the smaller mode field diameter.

As fibers 12 of different mode field diameters can be associated with different currents, such fibers can have different requirements as far as the temperature profile, or heat, required to splice the fiber to another. In this regard, the controller 20 can control the motors 22 to offset the fibers in the x direction (along the length of the fibers) from the axis 28 defined between the electrodes 16, as shown in FIG. 1. By offsetting the fibers, then, one of the fibers in each pair can be located in a region of the heat distribution that has a different heat level than the other fiber in each pair. In this regard, the fibers can be positioned such that the fiber of each pair that splices with a lower temperature can be within a region of the heat distribution that provides a lower level of heat than the region within which the other fiber of each pair reside.

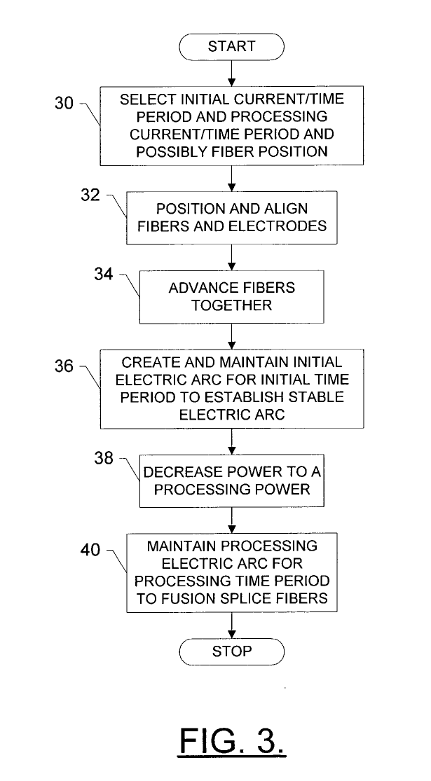

Referring now to FIG. 3, in operation, the initial current and initial time period, as well as the processing current and processing time period, are selected, as shown in block 30. In this regard, the respective currents and times are selected based upon a number of different factors such as, for example, the electrode gap, the doping materials in the optical fibers 12 (e.g., core and cladding) and the fiber structures (e.g., refraction index profile and mode field diameter), to thereby achieve an optimized temperature condition. In addition to selecting the respective currents and times, the relative offset of the fibers in the z and/or x directions from the electrodes can be selected, such as described above. After selecting the respective currents and times, the pairs of fibers are aligned and positioned relative to one another such that ends of the fibers face one another and the ends are separated by a gap, such as approximately 20 microns, as such is known to those skilled in the art. If the ends of the fibers have not previously been prepared for splicing, however, the ends of the fibers can be prepared before positioning the fibers. In this regard, the fiber coatings can be removed from end portions of the fibers, and thereafter the fibers can be cleaved to expose the ends. The fibers are then positioned between the electrodes 16, as shown in block 32. In this regard, , the fibers can be positioned such that the ends of the fibers are offset in the z and/or x directions from the axis 28 defined between the electrodes, as described above.

After positioning the fibers 12, the ends of the fibers are advanced toward on another, as shown in block 34. As the fibers are advanced toward one another, and just before contact of the fiber ends, the initial current is passed between the electrodes to create and maintain the initial electric arc 18 between the electrodes for the initial time period, as shown in block 36. The initial electric arc can therefore heat the fibers as the fibers are advanced toward one another, and before contact of the fibers. In this regard, the fiber ends are positioned and advanced such that the fiber ends of each pair of fibers contact one another during the initial time period. For example, in the example indicated above and described below in conjunction with FIG. 5 where the initial current and initial time are selected to be 27.3 mA and 3 seconds, respectively, the initial electric arc can preheat the ends of the fibers for 0.1 seconds before the ends contact one another and continue to heat the fibers in contact for the remaining 2.9 seconds. It will be appreciated that after the ends of the fiber contact, force can continue to be applied to the ends of the fibers for a time period to thereby press the ends together during the splicing process. Such a process of applying force to the ends of the fibers after the ends contact is often referred to as overlapping.

As will be appreciated by those skilled in the art, as the initial current is passed between the electrodes 16, a breakthrough discharge will occur between the electrodes. Such a breakthrough voltage, which is due to insulation breakdown in the gap between the electrodes, will typically be created by a very large trigger voltage (e.g., 10 kV) and a corresponding very low trigger current (e.g., 0-5 mA). In this regard, the trigger voltage will typically be larger than the voltage across the electrodes as the initial current and processing current are passed between the electrodes, and typically lasts for a time period in the nanosecond to microsecond, range. Following the breakthrough discharge, then, the voltage decreases to a defined level (e.g., 1 kV), which remains approximately constant for both the initial time period and the processing time period, with the current changing between the initial current and the processing current. As described herein, then, the initial time period typically includes the time period the breakthrough voltage occurs between the electrodes.

After the initial time period, the initial current is reduced to the processing current, as shown in block 38. The processing current is then applied across the electrodes 16 to create the processing electric arc, as shown in block 40. The processing electric arc is applied across the ends of the fibers 12 to be spliced to thereby heat the ends of the fibers. The processing electric arc is maintained for the processing period of time to fusion splice the fibers together.

As such, by splicing the fibers according to a two-step electric arc process by passing an initial current and thereafter a processing current, the present invention can splice the fibers with less loss in the splice than in splicing the fibers according to the conventional technique. In this regard, as the refractive index profiles of the fibers becomes more complicated, lower temperatures, and thus lower power electric arcs, are typically required to avoid high losses in the splices. The conventional one-step electric arc splicing technique cannot utilize the preferred, lower temperature electric arc throughout the splicing process, however, because the long electrode gap will preclude establishing a stable arc at such a low power. Thus, the conventional technique typically must utilize the high power electric arc, which will result in a stable electric arc to splice the fibers, but will also result in overheating of the fibers and higher losses in the splices. In contrast, the system, method and controller of embodiments of the present invention can splice large numbers of fibers simultaneously by establishing a stable electric arc by passing the higher, initial current across the electrodes to create a higher power initial electric arc. Then, to splice the fibers with lower losses (with a more desirable temperature), the higher power initial electric arc is reduced to the processing electric arc created by passing the processing current between the electrodes.

To more clearly illustrate the benefits of embodiments of the present invention, consider the following two examples where various combinations of fibers 12 were spliced together according to a conventional technique and according to embodiments of the present invention. In the examples, the fibers comprise Allwave (AW) model fibers and/or Truewave (TW) model fibers.

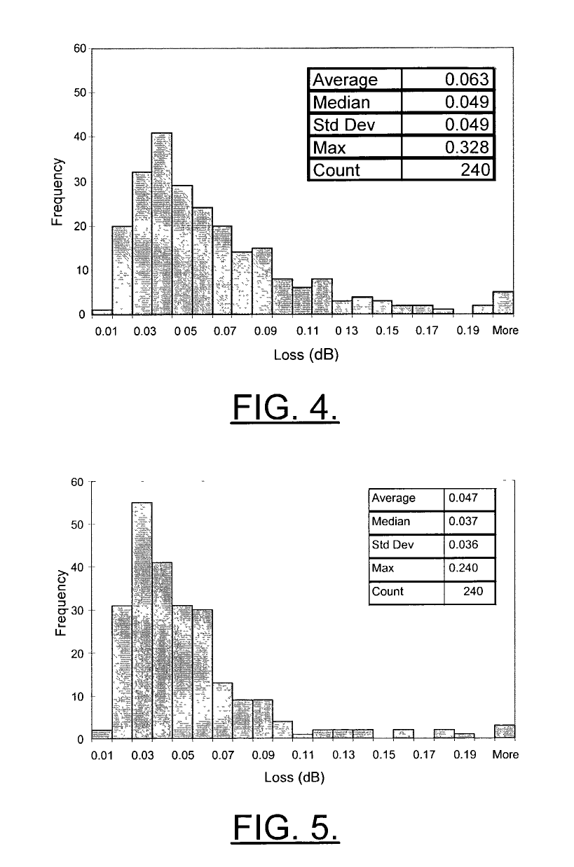

According to the first example, TW fibers were fusion spliced to other TW fibers according to both the conventional technique utilizing a one-step electric arc, and according to embodiments of the present invention utilizing an initial electric arc and a processing electric arc. First, ten ribbons of twenty-four TW fibers were fusion spliced to ten other ribbons of twenty-four TW fibers according to the conventional technique. In this regard, for each ribbon of twenty-four TW fibers fusion spliced to another ribbon of twenty-four TW fibers, 24.6 mA of current was passed between electrodes for a duration of 14 seconds. The splice for each fiber of each ribbon of the ten different 24-fiber splices were then measured, for a total of 240 individual splices or measurements. As shown in FIG. 4, when the TW fibers were spliced to other TW fibers according to the conventional splicing technique, the average splice loss for the TW-TW splices was 0.063 dB. Although such a loss is not significantly high, a large percentage of the population was well above this average, as shown in Table 1.

TABLE 1

| Number of Values | | |
|---|---|---|
| Above: | Total | Percent of population |
| 0.10 dB | 37 | 15.42 |
| 0.15 dB | 12 | 5.00 |
| 0.20 dB | 5 | 2.08 |
| 0.25 dB | 4 | 1.67 |
| 0.30 dB | 2 | 0.83 |

The results shown in Table 1 indicate that the conventional splicing technique is typically not sufficient for TW-TW splicing, particularly splicing of large numbers of fibers (e.g., 24 pairs of fibers). The conventional splicing technique produced inconsistent results with some splicing losses exceeding 0.30 dB. Further, over 15% of the splices were found to be over 0.10 dB. Although it may not be possible to completely eliminate all splice losses from exceeding 0.10 dB, it is obvious that additional optimization is required to improve splicing consistency. One of the main reasons why losses in the TW-TW fibers spliced according to the conventional technique were inconsistent and high is that, given the large electrode gap, it is very difficult for the conventional splicing technique to deliver a stable and consistent temperature profile that is necessary for certain fusion temperature sensitive fibers such as TrueWave (TW) fibers.

To demonstrate how the splice losses for TW-TW fibers can be reduced by splicing the fibers according to the present invention, another ten ribbons of twenty-four TW fibers were fusion spliced to ten other ribbons of twenty-four TW fibers according to embodiments of the present invention. For each ribbon of twenty-four TW fibers fusion spliced to another ribbon of twenty-four TW fibers, an initial current of 27.3 mA was passed between electrodes for an initial time period of 3 seconds to establish a stable electric arc. After the stable arc was established, a processing current of 23.1 mA was passed between the electrodes for a processing time period of 12 seconds to fusion splice the fibers together. The splice for each fiber of each ribbon for the ten different 24-fiber splices was then measured, for a total of 240 individual splices or measurements.

As shown in FIG. 5, after splicing TW fibers with other TW fibers according to embodiments of the present invention, the average splicing loss for TW-TW was reduced from 0.063 dB to 0.047 dB. In addition, as shown in Table 2, the percentage of the population above 0.10 dB loss is dramatically reduced from 15% to 6%, which means that the splicing loss consistency has also been largely improved. As a result, consistently low loss for TW-TW splicing can be achieved by splicing the fibers according to embodiments of the present invention.

TABLE 2

| Number of Values | | |
|---|---|---|
| Above: | Total | Percent of population |
| 0.10 dB | 15 | 6.25 |
| 0.15 dB | 8 | 3.33 |
| 0.20 dB | 3 | 1.25 |
| 0.25 dB | 0 | 0.00 |
| 0.30 dB | 0 | 0.00 |

In the second example, TW fibers were fusion spliced to AW fibers. Like in the first example, ten ribbons of twenty-four TW fibers were fusion spliced to ten ribbons of twenty-four AW fibers according to the conventional technique. For each ribbon of twenty-four fibers fusion spliced to another ribbon of twenty-four fibers, then, 26.4 mA of current was passed between electrodes for a duration of 15 seconds. The splice for each fiber of each ribbon for the ten different 24-fiber splices was then measured, for a total of 240 individual splices or measurements. Due to the mode field diameter difference between the two fiber types and an unstable electric arc between the electrodes, higher losses over the order of 0.10 dB were obtained when the fibers were spliced according to the conventional technique.

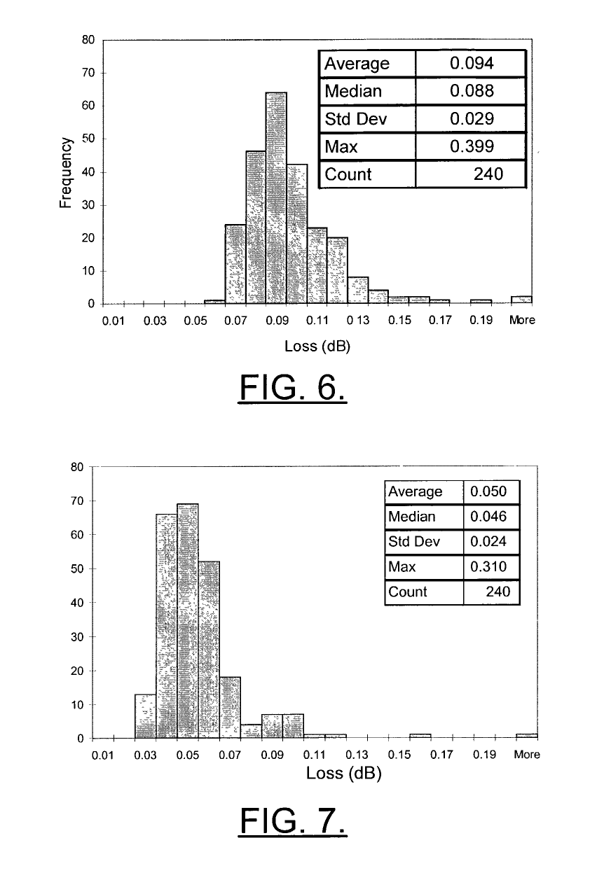

As shown in FIG. 6, the results indicate that the conventional splicing technique, like TW-TW splicing, would typically not be sufficient for TW-AW fiber splicing. In this regard, the conventional splicing technique produced relatively high average splice losses. The results also indicated that over 25% of the sample population had a splice loss over 0.10 dB, which indicates very inconsistent results, as shown in Table 3. It is clear, then, that additional optimization or improvement is desired to not only lower the overall average splice loss, but also reduce the number of splices exceeding 0.10 dB.

TABLE 3

| Number of Values | | |
|---|---|---|
| Above: | Total | Percent of population |
| 0.10 dB | 66 | 27.50 |
| 0.15 dB | 7 | 2.92 |
| 0.20 dB | 2 | 0.83 |
| 0.25 dB | 1 | 0.42 |
| 0.30 dB | 1 | 0.42 |

Like the reason why losses in TW-TW fibers spliced according to the conventional technique were high, AW-TW fibers spliced according to the conventional technique were inconsistent and high because, given the large electrode gap, it is very difficult for the conventional splicing technique to deliver a stable and consistent temperature profile that is necessary for certain fusion temperature sensitive fibers such as TrueWave (TW) fibers and AllWave (AW) fibers. To demonstrate how the splice losses for the TW-AW fiber ribbons can be reduced by splicing the respective fibers according to embodiments of the present invention, then, ribbons of TW fibers were spliced to ribbons of AW fibers according to the present invention.

More particularly, each ribbon of twenty-four TW fibers was fusion spliced to a ribbon of twenty-four AW fibers. First, an initial current of 27.3 mA was passed between electrodes for an initial time period of 2 seconds to establish a stable electric arc. After the stable arc was established, a processing current of 21.9 mA was passed between the electrodes for a processing time period of 20 seconds to fusion splice the fibers together. The splice for each fiber of each ribbon for the ten different 24-fiber splices was then measured, for a total of 240 individual splices or measurements. As shown in FIG. 7, after splicing the fibers according to embodiments of the present invention, the average splicing loss for TW-AW was dramatically reduced from 0.094 dB to 0.050 dB. As shown in Table 4, the percentage of the population above 0.10 dB loss was radically reduced from over 25% to 2%. In this regard, the splicing loss consistency has also been greatly improved. Therefore, by splicing the fibers according to the present invention, consistently low loss for dissimilar TW-AW fiber splicing has been also achieved.

TABLE 4

| Number of Values | | |
|---|---|---|
| Above: | Total | Percent of population |
| 0.10 dB | 4 | 1.67 |
| 0.15 dB | 2 | 0.83 |
| 0.20 dB | 1 | 0.42 |
| 0.25 dB | 1 | 0.42 |
| 0.30 dB | 1 | 0.42 |

Thus, embodiments of the present invention provide an improved system, controller and method of fusion splicing pairs of optical fibers together. The system, controller and method are capable of fusion splicing a large number of pairs of fibers without increasing losses in the fibers in the same manner as fusion splicing large numbers of fibers according to conventional techniques. In this regard, the system, controller and method are capable of passing a higher, initial current between electrodes to establish a stable electric arc between the electrodes. To fusion splice the fibers without overheating the ends of the fibers then, the system, controller and method of embodiments of the present invention can pass a lower, processing current between the electrodes to fusion splice the fibers together.

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A system for fusion splicing at least one pair of optical fibers together, the system comprising:
a pair of electrodes positioned on either side of the at least one pair of optical fibers, wherein the pair of electrodes are capable of passing an electric current therebetween to create an electric arc; and
a controller capable of controlling the electrodes to thereby pass the current therebetween to create the electric arc, wherein the controller is capable of controlling the electrodes to pass an initial current to thereby create and maintain an initial electric arc and thereafter pass a processing current to thereby create and maintain a processing electric arc, wherein the initial current is higher than the processing current.

2. A system according to claim 1, wherein the controller is capable of controlling the electrodes based upon at least one characteristic of the at least one pair of optical fibers.

3. A system according to claim 1, wherein the controller is capable of controlling the electrodes to maintain the initial electric arc for an initial period of time, and thereafter maintain the processing electric arc for a processing period of time, and wherein the initial period of time is shorter than the processing period of time.

4. A system according to claim 3, wherein the controller is capable of selecting the initial current and the processing current based upon at least one characteristic of the at least one pair of optical fibers.

5. A system according to claim 1, wherein the pair of electrodes define an axis therebetween, and wherein the ends of the at least one pair of optical fibers are offset in at least one direction by a predefined distance from the axis.

6. A system according to claim 5, wherein the ends of the at least one pair of optical fibers are positioned such that ends face one another and the fibers extend longitudinally therefrom in opposing directions, and wherein the ends of the at least one pair of optical fibers are offset longitudinally by a predefined distance from the axis.

7. A system according to claim 1, wherein at least one of the at least one pair of optical fibers includes a first optical fiber having a first mode field diameter and a second optical fiber having a second mode field diameter, and wherein the first mode field diameter is larger than the second mode field diameter.

8. A system according to claim 1, wherein the system is capable of fusion splicing at least twenty-four pairs of optical fibers together.

9. A method of fusion splicing optical fibers comprising:
positioning at least one pair of optical fibers between at least one pair of electrodes;
passing an initial current between the electrodes to thereby create an initial electric arc between the electrodes; and
passing a processing current between the electrodes to thereby create a processing electric arc between the electrodes, wherein the initial current is higher than the processing current.

10. A method according to claim 9, wherein passing the initial current comprises passing the initial current to create and maintain the initial electric arc for an initial period of time, and wherein passing the processing current comprises passing the processing current to create and maintain the processing electric arc for a processing period of time, and wherein the initial period of time is shorter than the processing period of time.

11. A method according to claim 10 further comprising selecting a level of the initial electric arc before passing the initial current, selecting a level of the, processing electric arc before passing the processing current, wherein the level of the initial electric arc and processing electric arc are selected based upon at least one characteristic of the at least one pair of optical fibers.

12. A method according to claim 9, wherein the pair of electrodes define an axis therebetween, and wherein positioning the at least one pair of optical fibers comprises positioning the at least one pair of optical fibers such that ends of the at least one pair of optical fibers are offset in at least one direction by a predefined distance from the axis.

13. A method according to claim 12, wherein positioning the at least one pair of optical fibers comprises positioning the at least one pair of optical fibers such that ends of each pair face one another and the optical fibers extend longitudinally therefrom in opposing directions, and such that the ends of the at least one pair of optical fibers are offset longitudinally by a predefined distance from the axis.

14. A method according to claim 9 further comprising providing at least one pair of optical fibers including a first optical fiber having a first mode field diameter and a second optical fiber having a second mode field diameter, wherein the first mode field diameter is larger than the second mode field diameter.

15. A controller for controlling a pair of electrodes to fusion splice optical fibers, the controller comprising:
a processor capable of driving at least one pair of optical fibers into a position between the pair of electrodes, wherein the processor is also capable of passing an initial current between the electrodes to thereby create an initial electric arc between the electrodes, and wherein the processor is capable of passing a processing current between the electrodes to thereby create a processing electric arc between the electrodes, wherein the initial current is higher than the processing current.

16. A controller according to claim 15, wherein the processor is capable of passing the initial current to create and maintain the initial electric arc for an initial period of time, wherein the processor is capable of passing the processing current to create and maintain the processing electric arc for a processing period of time, and wherein the initial period of time is shorter than the processing period of time.

17. A controller according to claim 16, wherein the processor is further capable of selecting a level of the initial electric arc before passing the initial current, and selecting a level of the processing electric arc before passing the processing current, and wherein the level of the initial electric arc and processing electric arc are selected based upon at least one characteristic of the at least one pair of optical fibers.

18. A controller according to claim 15, wherein the pair of electrodes define an axis therebetween, and the processor is capable of driving the pair of electrodes into position such that ends of the at least one pair of optical fibers are offset by a predefined distance from the axis.

19. A controller according to claim 18, wherein the controller is further capable of driving the at least one pair of optical fibers into alignment such that ends of each pair face one another and the optical fibers extend longitudinally therefrom in opposing directions, and wherein the controller is capable of driving the at least one pair of electrodes into position such that the ends of the at least one pair of optical fibers are offset longitudinally by a predefined distance from the axis.
